(19) United States
(12) Patent Application Publication
(10) Pub. No.: US 2024/0428982 A1
(43) Pub. Date: Dec. 26, 2024

(54) INDUCTOR COMPONENT

(71) Applicant: Murata Manufacturing Co., Ltd., Kyoto-fu (JP)

(72) Inventors: Yuuichirou YOSHIDA, Nagaokakyo-shi (JP); Kenichi TANI, Nagaokakyo-shi (JP)

(73) Assignee: Murata Manufacturing Co., Ltd., Kyoto-fu (JP)

(21) Appl. No.: 18/737,351

(22) Filed: Jun. 7, 2024

(30) Foreign Application Priority Data
Jun. 22, 2023 (JP) 2023-102301

(51) Int. Cl. H01F 27/28; H01F 27/24; H01F 27/29

(52) U.S. Cl. CPC H01F 27/2804; H01F 27/24; H01F 27/29; H01F 2027/2809

(57) ABSTRACT

An inductor component includes a body, a coil in the body and helically wound about an axis, and first and second outer electrodes disposed at the body and electrically connected to the coil. The axis is parallel to the bottom surface of the body and crosses the first and second side surfaces of the body. The coil includes first and second coil wiring layers laminated adjacent to each other in the axial direction, and a first via wiring layer that connects the first and second coil wiring layers. The first coil wiring layer has a first coil end portion. The first via wiring layer has a first via end portion. At least the first via end portion of the first via wiring layer is connected to a portion of the first coil wiring layer closer to the first coil end portion.

### CROSS-REFERENCE TO RELATED APPLICATION

This application claims benefit of priority to Japanese Patent Application No. 2023-102301, filed Jun. 22, 2023, the entire content of which is incorporated herein by reference.

### BACKGROUND

### Technical Field

The present disclosure relates to an inductor component.

### Background Art

An example of an existing inductor component is described in Japanese Unexamined Patent Application Publication No. 2000-286125. This inductor component includes a body, a coil disposed in the body and helically wound about an axis, and a first outer electrode and a second outer electrode disposed at the body and electrically connected to the coil. The coil includes multiple coil wiring layers laminated while being adjacent to one another in an axial direction, and multiple via wiring layers each located between the coil wiring layers adjacent to each other in the axial direction to connect the coil wiring layers adjacent to each other in the axial direction. During manufacture of an existing inductor component, a first insulating layer is disposed on a layer including a second coil wiring layer, the first insulating layer is processed to form a first hole for a first via wiring layer, a second insulating layer is then also disposed on the first insulating layer, the second insulating layer is processed to have a second hole for a first coil wiring layer, and the first and second holes are filled with an electroconductive material to have the first via wiring layer and the first coil wiring layer therein.

### SUMMARY

In an existing inductor component, when the first hole and the second hole are simultaneously filled with paste to simultaneously form the first via wiring layer and the first coil wiring layer connected to the first via wiring layer, the filling workability to fill magnetic paste into the first and second holes may degrade, the volume of the first via wiring layer may decrease, and the first via wiring layer may be poorly formed. Thus, connectivity between the first via wiring layer and the second coil wiring layer may degrade.

Accordingly, the present disclosure provides an inductor component having improved connectivity between a via wiring layer and a coil wiring layer.

To address the above issue, an inductor component according to an aspect of the present disclosure includes a body, a coil disposed in the body and helically wound about an axis, and a first outer electrode and a second outer electrode disposed at the body and electrically connected to the coil. The body has a first end surface and a second end surface opposite to each other, a first side surface and a second side surface opposite to each other, a bottom surface that connects the first end surface and the second end surface to each other and connects the first side surface and the second side surface to each other, and a top surface opposite to the bottom surface. The axis is parallel to the bottom surface and crosses the first side surface and the second side surface. The coil includes a first coil wiring layer and a second coil wiring layer laminated adjacent to each other in the axial direction, and a first via wiring layer that connects the first coil wiring layer and the second coil wiring layer to each other. The first coil wiring layer has a first coil end portion, and the first via wiring layer has a first via end portion. Also, at least the first via end portion of the first via wiring layer is connected to a portion of the first coil wiring layer closer to the first coil end portion. In addition, when viewed in the axial direction, the first coil end portion of the first coil wiring layer is spaced apart from the first via end portion of the first via wiring layer without overlapping the first via end portion.

When viewed in the axial direction, the first coil end portion of the first coil wiring layer is spaced apart from the first via end portion of the first via wiring layer without overlapping the first via end portion. Thus, the first via wiring layer has improved filling workability, and secures a contact area between the second coil wiring layer and the first via wiring layer. Thus, the first via wiring layer and the second coil wiring layer has preferably connectivity.

To address the above issue, an inductor component according to an aspect of the present disclosure includes a body, a coil disposed in the body and helically wound about an axis, and a first outer electrode and a second outer electrode disposed at the body and electrically connected to the coil. The body has a first end surface and a second end surface opposite to each other, a first side surface and a second side surface opposite to each other, a bottom surface that connects the first end surface and the second end surface to each other and connects the first side surface and the second side surface to each other, and a top surface opposite to the bottom surface. The axis is parallel to the bottom surface and crosses the first side surface and the second side surface. The coil includes a first coil wiring layer and a second coil wiring layer laminated adjacent to each other in the axial direction, and a first via wiring layer that connects the first coil wiring layer and the second coil wiring layer to each other. The first coil wiring layer has a first coil end portion, and the first coil end portion has a first coil endmost portion located at an endmost portion in an extension direction of the first coil wiring layer. The first via wiring layer has a first via end portion, and the first via end portion has a first via endmost portion located at an endmost portion in an extension direction of the first via wiring layer. Also, at least the first via end portion of the first via wiring layer is connected to a portion of the first coil wiring layer closer to the first coil end portion. In addition, a distance between the first coil endmost portion of the first coil wiring layer and the first via endmost portion of the first via wiring layer is greater than or equal to 10 μm.

The first coil end portion of the first coil wiring layer is an area surrounded by, when viewed in the axial direction, an end portion that connects ends of an inner peripheral surface and an outer peripheral surface parallel to each other, and a straight line passing the end of the inner peripheral surface and the end of the outer peripheral surface. A portion of the first coil wiring layer closer to the first coil end portion is a portion of the first coil wiring layer closer to the first coil end portion with respect to a center line that passes the middle of the length of the first coil wiring layer in the extension direction and that is perpendicular to the extension direction of the first coil wiring layer. The first coil endmost portion of the first coil wiring layer is a point located at the endmost portion in the extension direction of the first coil wiring layer when viewed in the axial direction. The same holds true for the first via end portion of the first via wiring layer and the first via endmost portion of the first via wiring layer.

The distance between the first coil endmost portion of the first coil wiring layer and the first via endmost portion of the first via wiring layer is greater than or equal to 10 μm. Thus, the first via wiring layer has improved filling workability, and secures a contact area between the second coil wiring layer and the first via wiring layer. Thus, the first via wiring layer and the second coil wiring layer has preferably connectivity.

An inductor component according to an aspect of the present disclosure has improved connectivity between the via wiring layer and a coil wiring layer.

### BRIEF DESCRIPTION OF THE DRAWINGS

FIG. 1 is a perspective view of an inductor component according to a first embodiment;

FIG. 2 is a perspective front view of an inductor component viewed from a first side surface;

FIG. 3 is a partially enlarged diagram of the inductor component in FIG. 2;

FIG. 4 is an exploded plan view of an inductor component;

FIG. 5 is a cross-sectional view of an inductor component;

FIG. 6 is a perspective front view of an inductor component according to a third embodiment, when viewed in a direction from a first side surface of the inductor component;

FIG. 7 is an exploded plan view of an inductor component;

FIG. 8 is a cross-sectional view of an inductor component; and

FIG. 9 is a diagram illustrating an existing technology.

### DETAILED DESCRIPTION

An inductor component according to an aspect of the present disclosure is described in further detail below with illustrated embodiments. Some of the drawings are schematic, and may fail to reflect the actual dimensions or ratios.

### First Embodiment

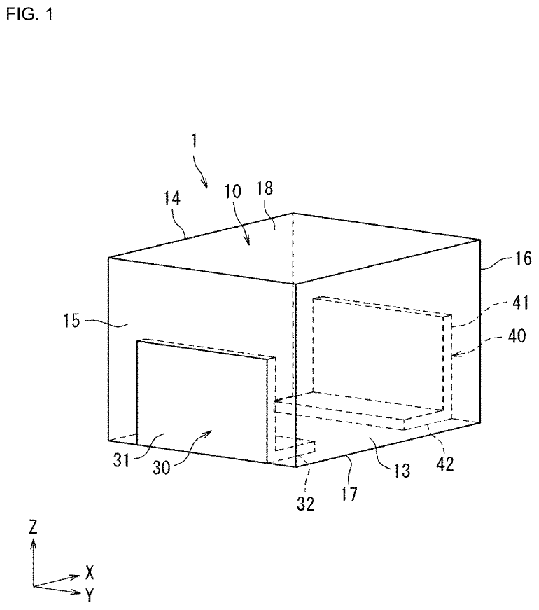

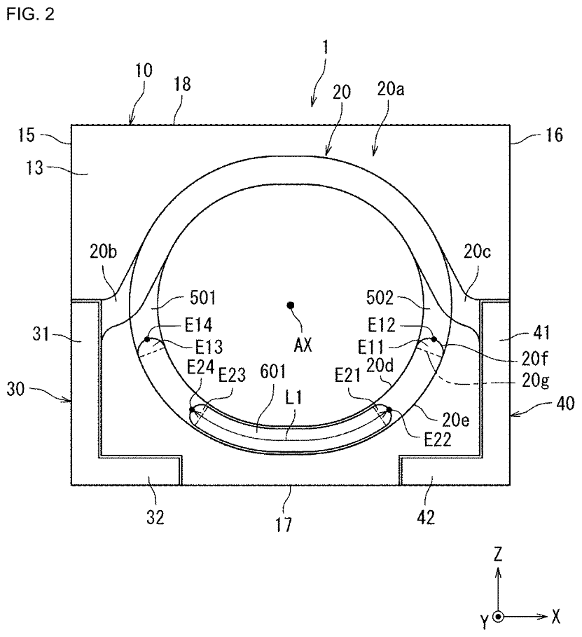

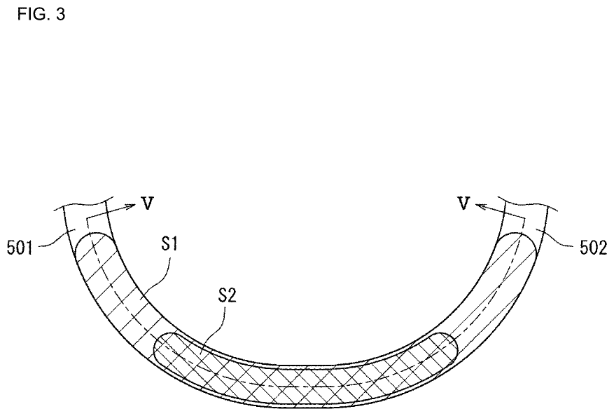

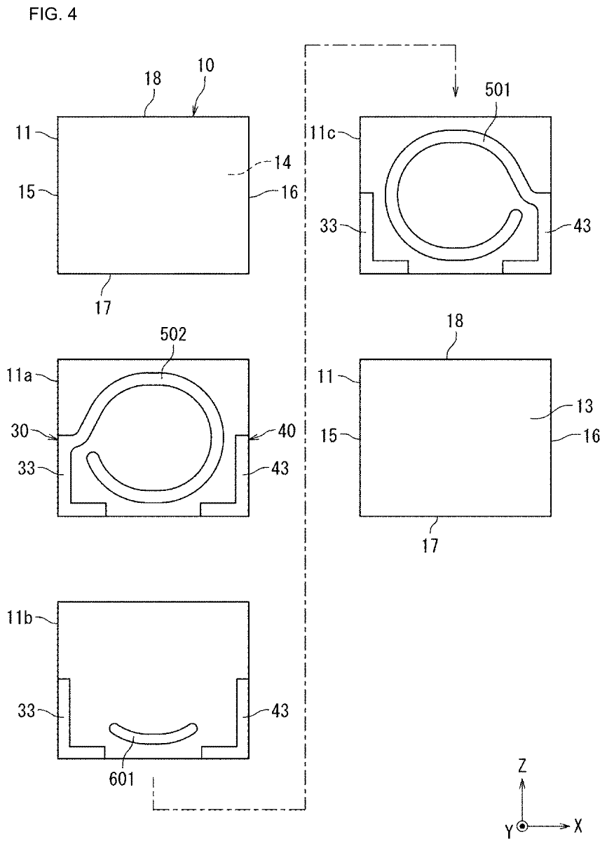

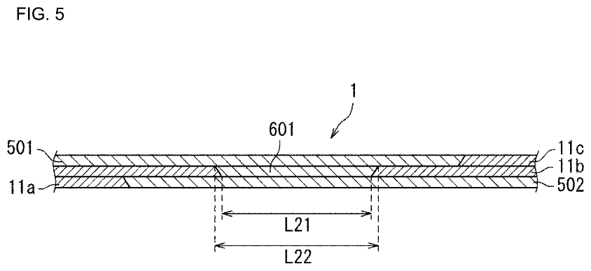

FIG. 1 is a perspective view of an inductor component according to a first embodiment. FIG. 2 is a perspective front view of an inductor component when viewed in a direction from a first side surface. FIG. 3 is a partially enlarged diagram of the inductor component in FIG. 2. FIG. 4 is an exploded plan view of an inductor component. FIG. 5 is a cross-sectional view of an inductor component taken along a center line in an extension direction of a via wiring layer. As illustrated in FIG. 1, FIG. 2, FIG. 3, FIG. 4, and FIG. 5, an inductor component 1 includes a body 10, a coil 20 disposed in the body 10 and helically wound about an axis AX, and a first outer electrode 30 and a second outer electrode 40 disposed on the body 10 and electrically connected to the coil 20. For convenience, or for ease of understanding the structure, FIG. 2 and FIG. 3 illustrate the body and the coil as being transparent, but they may be semitransparent or opaque.

The inductor component 1 is electrically connected to a wire of a circuit board not illustrated with the first and second outer electrodes 30 and 40. The inductor component 1 is, for example, used as an impedance matching coil (or matching coil) for a high-frequency circuit, and included in an electronic device, such as a personal computer, a digital video disk (DVD) player, a digital camera, a television set, a mobile phone, automotive electronics, or a medical/industrial machine. The purpose of use of the inductor component 1 is not limited to this, and the inductor component 1 is also usable in, for example, a tuning circuit, a filter circuit, or a rectification smoothing circuit.

The body 10 has a substantially rectangular prism shape. The body 10 has a first end surface 15 and a second end surface 16 opposite to each other, a first side surface 13 and a second side surface 14 opposite to each other, a bottom surface 17 that connects the first end surface 15 and the second end surface 16 to each other and connects the first side surface 13 and the second side surface 14 to each other, and a top surface 18 opposite to the bottom surface 17. When the inductor component 1 is mounted on a mount board not illustrated, the bottom surface 17 faces the mount board.

As illustrated, an X direction is a direction perpendicular to the first end surface 15 and the second end surface 16, directing from the first end surface 15 to the second end surface 16. A Y direction is a direction perpendicular to the first side surface 13 and the second side surface 14, directing from the second side surface 14 to the first side surface 13. A Z direction is a direction perpendicular to the bottom surface 17 and the top surface 18, directing from the bottom surface 17 to the top surface 18. The X direction is also referred to as a length direction of the body 10, the Y direction is also referred to as a width direction of the body 10, and the Z direction is also referred to as a height direction of the body 10. The X direction, the Y direction, and the Z direction are perpendicular to each other, and form a left-hand system when arranged in order of X, Y, and Z.

The X direction is also referred to as a length direction of the body 10, the Y direction is also referred to as a width direction of the body 10, and the Z direction is also referred to as a height direction of the body 10. The length direction is a direction in which the first end surface 15 and the second end surface 16 are opposite to each other, and parallel to the straight line connecting the first end surface 15 and the second end surface 16 to each other at a shortest distance. The width direction is a direction in which the first side surface 13 and the second side surface 14 are opposite to each other, and parallel to the straight line connecting the first side surface 13 and the second side surface 14 to each other at a shortest distance. The height direction is a direction in which the top surface 18 and the bottom surface 17 are opposite to each other, and parallel to the straight line connecting the top surface 18 and the bottom surface 17 to each other at a shortest distance.

The body 10 is formed by laminating multiple insulating layers 11. The insulating layers 11 are formed from a material such as a material containing borosilicate glass as a main component, ferrite, or resin. The insulating layers 11 are laminated in the direction parallel to the first and second end surfaces 15 and 16 and the bottom surface 17 of the body 10 (laminated in the Y direction). Specifically, the insulating layers 11 are layers expanding in the XZ plane. Herein, “parallel” is not limited to a parallel relationship in a strict sense, and includes a substantially parallel relationship in consideration of the range of actual variations. In the body 10, the interfaces between the multiple insulating layers 11 may be unclear due to, for example, firing. In FIG. 4, the direction from the upper left to the lower right is defined as a lamination direction (Y direction).

The first outer electrode 30 and the second outer electrode 40 are formed from an electroconductive material such as Ag, Cu, Au, or an alloy containing any of these as a main component. The first outer electrode 30 and the second outer electrode 40 may have surfaces exposed from the body 10 coated with, for example, Ni or Sn plating.

The first outer electrode 30 has an L shape extending from the first end surface 15 to the bottom surface 17. The first outer electrode 30 is embedded in the body 10 while being exposed from the first end surface 15 and the bottom surface 17. The first outer electrode 30 includes a first end surface portion 31 extending along the first end surface 15, and a first bottom surface portion 32 connected to the first end surface portion 31 and extending along the bottom surface 17.

The second outer electrode 40 has an L shape extending from the second end surface 16 to the bottom surface 17. The second outer electrode 40 is embedded in the body 10 while being exposed from the second end surface 16 and the bottom surface 17. The second outer electrode 40 includes a second end surface portion 41 extending along the second end surface 16, and a second bottom surface portion 42 connected to the second end surface portion 41 and extending along the bottom surface 17.

The first outer electrode 30 has a structure including multiple laminated first outer electrode conductor layers 33 embedded in the body 10 (insulating layers 11). The second outer electrode 40 has a structure including multiple second outer electrode conductor layers 43 embedded in the body 10 (insulating layers 11). The first outer electrode conductor layers 33 extend along the first end surface 15 and the bottom surface 17, and the second outer electrode conductor layers 43 extend along the second end surface 16 and the bottom surface 17.

The first and second outer electrodes 30 and 40 can thus be embedded in the body 10. The inductor component with this structure can have a smaller size than an inductor component with a structure where outer electrodes are externally attached to the body 10. In addition, the coil 20 and the first and second outer electrodes 30 and 40 can be formed in the same process. The positional relationship between the coil 20 and the first and second outer electrodes 30 and 40 thus has fewer variations, and the inductor component 1 can have electric characteristics with fewer variations.

The first outer electrode 30 may be formed from the first bottom surface portion 32 without including the first end surface portion 31. Similarly, the second outer electrode 40 may be formed from the second bottom surface portion 42 without including the second end surface portion 41. More specifically, the first outer electrode 30 and the second outer electrode 40 may be disposed on at least the bottom surface 17 of the body 10.

The coil 20 is formed from, for example, the same electroconductive material as the first and second outer electrodes 30 and 40. The coil 20 is helically wound about the direction in which the insulating layers 11 are laminated. The first end of the coil 20 is connected to the first outer electrode 30, and the second end of the coil 20 is connected to the second outer electrode 40. In the present embodiment, the coil 20 and the first and second outer electrodes 30 and 40 are integrated without clear boundaries. Instead, the coil and the outer electrodes may be formed from different materials or by different methods to have boundaries therebetween.

The coil 20 is wound about the axis AX that is parallel to the bottom surface 17, and that crosses the first side surface 13 and the second side surface 14. The axis AX of the coil 20 coincides with the direction in which the insulating layers 11 are laminated (the Y direction). In other words, the multiple insulating layers 11 are laminated along the axis AX. The axis AX of the coil 20 indicates the center axis of the helical shape of the coil 20. More specifically, the axis AX indicates the center of the innermost circumference of the coil 20.

The coil 20 includes a wound portion 20a, a first extended portion 20b that connects the first end of the wound portion 20a and the first outer electrode 30 to each other, and a second extended portion 20c that connects the second end of the wound portion 20a and the second outer electrode 40 to each other. In the present embodiment, the wound portion 20a and the first and second extended portions 20b and 20c are integrated without clear boundaries. Instead, the wound portion and the extended portions may be formed from different materials or by different methods to have boundaries therebetween.

The wound portion 20a is helically wound about the axis AX. More specifically, the wound portion 20a indicates a helically wound portion where the portions of the coil 20 overlap when viewed in the direction parallel to the axis AX. The first and second extended portions 20b and 20c are portions deviating from the overlapping portions.

When viewed in the direction of the axis AX of the coil 20, the coil 20 has a shape of bilateral symmetry with respect to the straight line crossing the axis AX of the coil 20 and parallel to the Z direction. The inductor component 1 with this structure thus has fewer characteristic variations.

As illustrated in FIG. 4, the coil 20 includes two coil wiring layers, or a second coil wiring layer 502 and a first coil wiring layer 501 laminated along the axis AX, and a first via wiring layer 601 located between the first and second coil wiring layers 501 and 502 adjacent in the direction of the axis AX and connecting the first and second coil wiring layers 501 and 502 adjacent in the direction of the axis AX to each other. The second coil wiring layer 502 is disposed at a first insulating layer 11a, the first via wiring layer 601 is disposed at a second insulating layer 11b, and the first coil wiring layer 501 is disposed at a third insulating layer 11c. Although the present embodiment includes two coil wiring layers, three or more coil wiring layers may be included. Although the coil wiring layers have less than one turn, they may have one or more turns.

The first and second coil wiring layers 501 and 502 are wound along the planes, and form a helix while being electrically connected in series to each other. The coil wiring layers are wound along the XZ plane (main surfaces of the insulating layers 11) perpendicular to the direction of the axis AX (Y direction). The coil wiring layers 501 and 502 each have a uniform width through its length.

The first coil wiring layer 501 has a first coil end portion E11, and a second coil end portion opposite to the first coil end portion E11. The first coil end portion E11 is an area surrounded by, when viewed in a direction of an axis AX, a coil end portion 20f that connects ends of an inner peripheral surface 20d and an outer peripheral surface 20e parallel to each other, and a virtual straight line 20g passing the end of the inner peripheral surface 20d and the end of the outer peripheral surface 20e.

The second coil wiring layer 502 has a first coil end portion E13 and a second coil end portion opposite to the first coil end portion E13. The first coil end portion E13 is an area defined in the same manner as the first coil end portion E11 of the first coil wiring layer 501.

More specifically, the second coil wiring layer 502 and the first coil wiring layer 501 are laminated in order in the Y direction. The second coil end portion of the second coil wiring layer 502 is connected to the first outer electrode conductor layers 33 of the first outer electrode 30. The second coil end portion of the first coil wiring layer 501 is connected to the second outer electrode conductor layers 43 of the second outer electrode 40.

The first via wiring layer 601 extends through the second insulating layer 11b in a thickness direction (Y direction). The coil wiring layers adjacent to each other in the lamination direction are electrically connected in series to each other with the via wiring layer interposed therebetween. Thus, the first and second coil wiring layers 501 and 502 form a helix of the coil 20 while being electrically connected in series to each other with the first via wiring layer 601 interposed therebetween.

The first via wiring layer 601 is located between the first coil wiring layer 501 and the second coil wiring layer 502 in the direction of the axis AX to connect the first coil wiring layer 501 and the second coil wiring layer 502 to each other.

When viewed in the direction of the axis AX, the first via wiring layer 601 is a longitudinal via wiring layer extending in the helical direction of the coil 20. The first via wiring layer 601 has a uniform width through its length. In the structure, the contact area between the first and second coil wiring layers 501 and 502 and the first via wiring layer 601 can be increased, and the direct current resistance of the coil 20 can be reduced. During manufacturing of the inductor component 1, regardless of when the first and second coil wiring layers 501 and 502 and the first via wiring layer 601 are laminated while being misaligned, the first and second coil wiring layers 501 and 502 and the first via wiring layer 601 are highly likely in contact with each other since the first via wiring layer 601 has a large area facing the first and second coil wiring layers 501 and 502. The present embodiment can thus reduce the possibility of the faulty electrical continuity between the first and second coil wiring layers 501 and 502 and the first via wiring layer 601. The present embodiment can also reduce disconnection of the first via wiring layer 601.

The first via wiring layer 601 has a first via end portion E21 and a second via end portion E23. In the first via wiring layer 601, a direction from the first via end portion E21 to the second via end portion E23 is the same as a direction from the first coil end portion E11 of the first coil wiring layer 501 to the second coil end portion of the first coil wiring layer 501. Here, the first via end portion E21 is an area surrounded by, when viewed in the direction of the axis AX, a via end portion that connects ends of the inner peripheral surface 20d and the outer peripheral surface 20e parallel to each other, and a virtual straight line passing the end of the inner peripheral surface 20d and the end of the outer peripheral surface 20e. The second via end portion E23 is an area defined in the similar manner as the first via end portion E21.

The first via end portion E21 of the first via wiring layer 601 is connected to a portion of the first coil wiring layer 501 closer to the first coil end portion E11. When viewed in the direction of the axis AX, the first coil end portion E11 of the first coil wiring layer 501 is spaced apart from the first via end portion E21 of the first via wiring layer 601 without overlapping the first via end portion E21. The above structure improves the filling workability of the first coil wiring layer 501 and the first via wiring layer 601, secures the contact area between the first via wiring layer 601 and the second coil wiring layer 502, and improves the connectivity between the first via wiring layer 601 and the second coil wiring layer 502. Here, the portion of the first coil wiring layer 501 closer to the first coil end portion E11 is a portion of the first coil wiring layer 501 closer to the first coil end portion E11 with respect to a center line that passes the middle of the length of the first coil wiring layer 501 in the extension direction, and that is perpendicular to the extension direction of the first coil wiring layer 501.

An inductor component 1P has been formed in the following manner. As illustrated in FIG. 9, in a cross section, a second coil wiring layer 502P, a first via wiring layer 601P, and a first coil wiring layer 501P are laminated in this order. More specifically, first, a second insulating layer 11B is disposed on a layer including a first insulating layer 11A and the second coil wiring layer 502P, and a first hole is formed in the second insulating layer 11B. A third insulating layer 11C having a second hole is then disposed on the second insulating layer 11B. At this time, when viewed in a lamination direction (the direction of the axis AX), the end portion of the third insulating layer 11C includes a position P, and the end portion of the second insulating layer 11B also includes the position P. In other words, when viewed in the lamination direction, the position of the end portion of the third insulating layer 11C and the position of the end portion of the second insulating layer 11B overlap each other. The first hole and the second hole are filled with electroconductive paste containing an electroconductive material to simultaneously form the first via wiring layer 601P and the first coil wiring layer 501P connected to the first via wiring layer 601P. However, a void V may be formed at a portion that fails to be filled with the electroconductive paste by being blocked by the third insulating layer 11C, that is located further in a filling direction (the direction of the axis AX), and that is located close to the second insulating layer 11B of the first via wiring layer 601P. Thus, the first via wiring layer 601P is more likely to fail to be filled with the electroconductive paste, and connectivity between the second coil wiring layer 502P and the first via wiring layer 601P may degrade. The end portion of the second insulating layer 11B and the end portion of the third insulating layer 11C overlap each other. Thus, a large recess may occur on a surface of the first coil wiring layer 501P above the void V and facing away from the first via wiring layer 601P at a portion close to the third insulating layer 11C, and also a large protrusion of the electroconductive material may occur on the third insulating layer 11C at a portion adjacent to the recess. When another material or another object collides with the protrusion, the first coil wiring layer 501P may be detached from the third insulating layer 11C.

In contrast, in the present embodiment, as illustrated in FIG. 5, in a cross-sectional view taken along the center line extending in the extension direction of the first via wiring layer 601, the first insulating layer 11a and the second coil wiring layer 502 are disposed, the second insulating layer 11b is then disposed thereon, and a first hole is formed in the second insulating layer 11b. The third insulating layer 11c having a second hole is disposed on the second insulating layer 11b. At this time, when viewed in the lamination direction (the direction of the axis AX), the end portion of the third insulating layer 11c and the end portion of the second insulating layer 11b are spaced apart from each other without overlapping each other. When the first hole and the second hole are filled with the electroconductive paste to simultaneously form the first via wiring layer 601 and the first coil wiring layer 501, the first coil end portion E11 of the first coil wiring layer 501 and the first via end portion E21 of the first via wiring layer 601 are spaced apart from each other without overlapping each other. Unlike an existing structure, the third insulating layer 11c does not prevent the holes from being filled. This structure can thus reduce the occurrence of voids V in the first via wiring layer 601, and improve the filling workability of the first via wiring layer 601. With the improvement of the filling workability, the contact area between the second coil wiring layer 502 and the first via wiring layer 601 can be secured, and the connectivity between the first via wiring layer 601 and the second coil wiring layer 502 is improved. In the present embodiment, the first coil end portion of the first coil wiring layer 501 and the first via end portion of the first via wiring layer 601 are spaced apart from each other without overlapping each other. Thus, a small or no recess occurs on the surface of the first coil wiring layer 501 facing away from the first via wiring layer 601. Thus, on the third insulating layer 11c, no protrusion of an electroconductive material occurs, or even if any protrusion occurs, the protrusion is small. Thus, collision with another material is less likely to occur, and the first coil wiring layer 501 is less likely to be detached from the third insulating layer 11c. Although a case where the first coil wiring layer 501 and the first via wiring layer 601 are simultaneously formed is described above, the first via wiring layer 601 and the second coil wiring layer 502 may be formed simultaneously. During manufacture, the first coil wiring layer 501 may be disposed on the second side surface 14 or on the first side surface 13. When the end portion of the second insulating layer 11b is spaced apart from the end portion of the third insulating layer 11c without overlapping and without changing the position of the end portion of the third insulating layer 11c, the volume of the first via wiring layer 601 is reduced. Thus, the difference in coefficient of linear expansion between the first via wiring layer 601 and the second insulating layer 11b is reduced, and thermal stress on the first via wiring layer 601 is reduced. Thus, the first via wiring layer 601 can reduce the occurrence of cracks.

Preferably, the second coil wiring layer 502 has a first coil end portion E13, the first via wiring layer 601 has a second via end portion E23 that is an end portion opposite to the first via end portion E21, at least the second via end portion E23 of the first via wiring layer 601 is connected to a portion of the second coil wiring layer 502 closer to the first coil end portion E13, and the first coil end portion E13 of the second coil wiring layer 502 is spaced apart from the second via end portion E23 of the first via wiring layer 601 without overlapping the second via end portion E23 when viewed in the direction of the axis AX. The first coil end portion E13 of the second coil wiring layer 502 is spaced apart from the second via end portion E23 of the first via wiring layer 601 without overlapping the second via end portion E23. Thus, regardless of when the first via wiring layer 601 is misaligned with the second coil wiring layer 502 during manufacture of the inductor component 1, the contact between the second coil wiring layer 502 and the first via wiring layer 601 can be secured.

Preferably, the first coil end portion E11 of the first coil wiring layer 501 has a first coil endmost portion E12 located at the endmost portion in the extension direction of the first coil wiring layer 501, the first via end portion E21 of the first via wiring layer 601 has a first via endmost portion E22 located at the located at the endmost portion in the extension direction of the first via wiring layer 601, and the distance between the first coil endmost portion E12 of the first coil wiring layer 501 and the first via endmost portion E22 of the first via wiring layer 601 is greater than or equal to 10 μm. The first coil endmost portion E12 of the first coil wiring layer 501 is a point located at the endmost portion in the extension direction of the first coil wiring layer 501 when viewed in the direction of the axis AX. The first via endmost portion E22 of the first via wiring layer 601 is a point located at the endmost portion in the extension direction of the first via wiring layer 601 when viewed in the direction of the axis AX.

Preferably, the distance between the first coil endmost portion E12 of the first coil wiring layer 501 and the first via endmost portion E22 of the first via wiring layer 601 is greater than or equal to the width of the first coil wiring layer 501. The width of the first coil wiring layer 501 is a dimension in the direction passing the middle in the direction in which the first coil wiring layer 501 extends, and perpendicular to the direction in which the first coil wiring layer 501 extends when viewed in the direction of the axis AX.

Preferably, the distance between the first coil endmost portion E12 of the first coil wiring layer 501 and the first via endmost portion E22 of the first via wiring layer 601 is greater than or equal to the length of the first via wiring layer 601. Here, the length of the first via wiring layer 601 is a length L1 of the center line in the direction in which the first via wiring layer 601 extends.

Preferably, when viewed in the direction of the axis AX, the first coil wiring layer 501 and the second coil wiring layer 502 overlap at least partially to have an overlapping portion, and an area S2 of the first via wiring layer 601 is equal to or smaller than 95% of an area S1 of the overlapping portion. Although not particularly limited, the area S2 of the first via wiring layer 601 may be equal to or greater than 2% of the area S1 of the overlapping portion. Here, the area S1 of the overlapping portion where the first coil wiring layer 501 and the second coil wiring layer 502 overlap is the area of the overlapping portion when viewed in the axial direction. The area S2 of the first via wiring layer is an area when viewed in the direction of the axis AX. The inductor component with the above structure can reduce the area of the first via wiring layer further than an existing inductor component, and can adjust an inductance (L value).

Preferably, in a cross section taken along the center line in the extension direction of the first via wiring layer 601, a length L22 of a contact portion between the first via wiring layer 601 and the first coil wiring layer 501 is greater than a length L21 of a contact portion between the first via wiring layer 601 and the second coil wiring layer 502. More specifically, in a cross section taken along the center line in the extension direction of the first via wiring layer 601, the first via wiring layer 601 has an inverted taper shape. The length L22 is longer than the length L21. Thus, regardless of when the second coil wiring layer 502 and the first via wiring layer 601 are misaligned to some extent, the first via wiring layer 601 can be easily formed on the first coil wiring layer 501, and the connectivity between the first via wiring layer 601 and the second coil wiring layer 502 can be secured.

The first coil end portion E13 of the second coil wiring layer 502 and a first coil endmost portion E14 of the second coil wiring layer 502 may have the same structure.

For example, the first coil end portion E13 of the second coil wiring layer 502 may have a first coil endmost portion E14 located at the endmost portion in the extension direction of the second coil wiring layer 502, the second via end portion E23 of the first via wiring layer 601 may have a second via endmost portion E24 located at the endmost portion in the extension direction of the first via wiring layer 601, and the distance between the first coil endmost portion E14 of the second coil wiring layer 502 and the second via endmost portion E24 of the first via wiring layer 601 may be greater than or equal to 10 μm. The first coil endmost portion E14 of the second coil wiring layer 502 and the second via endmost portion E24 of the first via wiring layer 601 are determined in the similar manner as the first coil endmost portion E12 of the first coil wiring layer 501.

The distance between the first coil endmost portion E14 of the second coil wiring layer 502 and the second via endmost portion E24 of the first via wiring layer 601 may be greater than or equal to the width of the second coil wiring layer 502. The width of the second coil wiring layer 502 indicates, when viewed in the direction of the axis AX, a dimension of the direction passing the middle in the direction in which the second coil wiring layer 502 extends and perpendicular to the direction in which the first coil wiring layer 501 extends.

The distance between the first coil endmost portion E14 of the second coil wiring layer 502 and the second via endmost portion E24 of the first via wiring layer 601 may be greater than or equal to the length of the first via wiring layer 601.

The present embodiment includes one via wiring layer, but may include multiple via wiring layers. When multiple via wiring layers are included, all the via wiring layers may be longitudinal via wiring layers. When multiple via wiring layers are included, at least one via wiring layer may be a longitudinal via wiring layer, and the other via wiring layers may be a circular (or quadrangular) via wiring layer when viewed in the direction of the axis AX. The coil end portion of the coil wiring layer connected to the circular via wiring layer forms a circular pad when viewed in the direction of the axis, and the diameter of the circular pad is greater than a line width of the coil wiring layer at an intermediate portion. When multiple via wiring layers are included, at least one of the via wiring layers may be spaced apart from the other via wiring layers.

### Manufacturing Method

Subsequently, a method for manufacturing the inductor component 1 is described.

As illustrated in FIG. 4, from the upper left to the lower right in the drawing, the second coil wiring layer 502, the first via wiring layer 601, and the first coil wiring layer 501 are alternately laminated with the insulating layers 11 interposed therebetween to manufacture the inductor component 1. The first and second coil wiring layers 501 and 502 are disposed on the insulating layers 11 by, for example, screen printing. The first via wiring layers 601 are formed by, for example, screen printing at holes formed in the insulating layers 11 by, for example, photolithography or laser printing.

### Second Embodiment

In the first embodiment, the first coil end portion of the first coil wiring layer is spaced apart from the first via end portion of the first via wiring layer without overlapping the first via end portion. In the second embodiment, regardless of whether the first coil end portion of the first coil wiring layer and the first via end portion of the first via wiring layer are spaced apart from each other, the coil endmost portion of the first coil wiring layer and the via endmost portion of the first via wiring layer may be spaced apart from each other by greater than or equal to 10 μm. These different components are described below. The other components are the same as those in the first embodiment, and thus are not described. The same drawings as those in the first embodiment are referred.

The distance between the first coil endmost portion E12 of the first coil wiring layer 501 and the first via endmost portion E22 of the first via wiring layer 601 is greater than or equal to 10 μm. With this structure, the occurrence of voids V in the first via wiring layer 601 is reduced, and the filling workability of the first via wiring layer 601 is improved. With the improved filling workability, the contact area between the second coil wiring layer 502 and the first via wiring layer 601 can be secured, and the connectivity between the first via wiring layer 601 and the second coil wiring layer 502 is improved. With the above structure, a small recess or no recess occurs on the surface of the first coil wiring layer 501 facing away from the first via wiring layer 601. Thus, on the third insulating layer 11c, no protrusion of an electroconductive material occurs, or even if any protrusion occurs, the protrusion is small. Thus, collision with another material will less likely to occur, and the first coil wiring layer 501 is less likely to be detached from the third insulating layer 11c.

Regardless of when the first coil end portion E11 of the first coil wiring layer 501 and the first via end portion E21 of the first via wiring layer 601 are spaced apart from each other without overlapping each other, or the first coil end portion E11 of the first coil wiring layer 501 and the first via end portion E21 of the first via wiring layer 601 overlap each other, the distance between the first coil endmost portion E12 of the first coil wiring layer 501 and the first via endmost portion E22 of the first via wiring layer 601 may be greater than or equal to 10 μm.

### Third Embodiment

In the first embodiment, when viewed in the axial direction, the via wiring layer overlaps the coil wiring layer. In the third embodiment, in contrast, the via wiring layer has an area not overlapping the coil wiring layer. These different components are described below. Other components are the same as those in the first embodiment, and are denoted with the same reference signs as those in the first embodiment without being described.

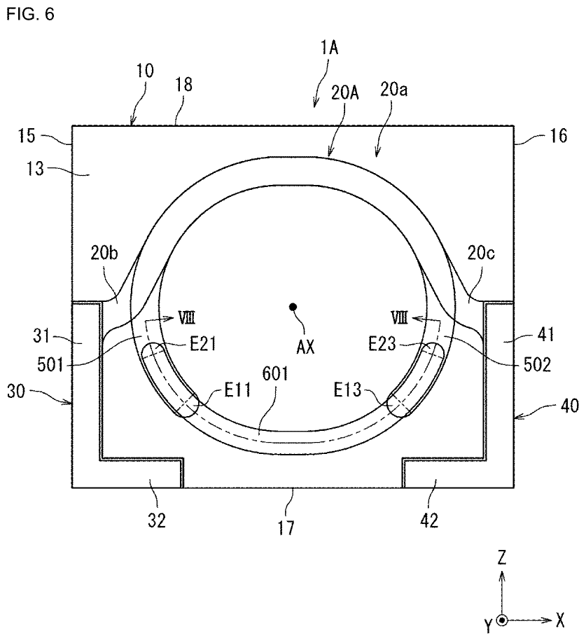

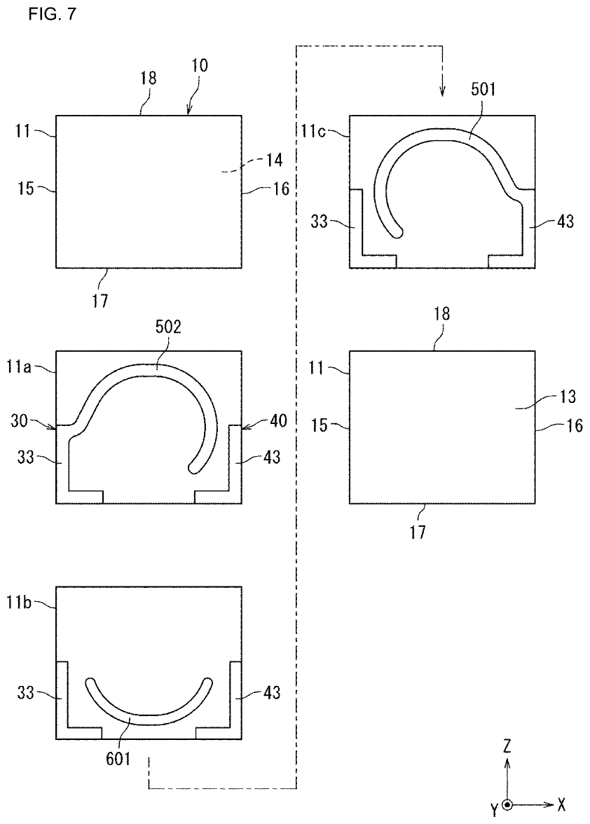

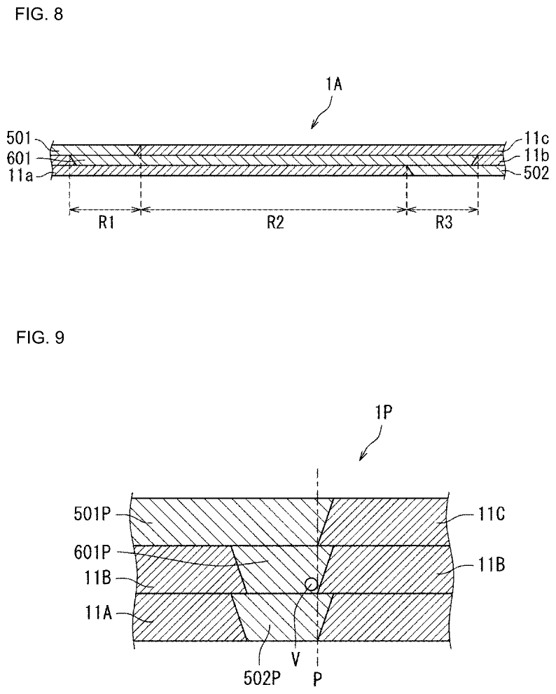

FIG. 6 is a perspective front view of an inductor component according to a third embodiment, when viewed in a direction from a first side surface of the inductor component. FIG. 7 is an exploded plan view of the inductor component. FIG. 8 is a cross-sectional view of the inductor component taken along a center line in the extension direction of the via wiring layer. For convenience, or for ease of understanding the structure, FIG. 6 illustrates the body and the coil as being transparent, but they may be semitransparent or opaque.

As illustrated in FIG. 6, FIG. 7, and FIG. 8, in an inductor component 1A, the first coil wiring layer 501 has a first contact portion R1 at a portion that is in contact with the first via wiring layer 601. In the present embodiment, the number of turns of the first coil wiring layer 501 is smaller than that in the case of the first embodiment. The first coil end portion E11 of the first coil wiring layer 501 does not overlap the second coil wiring layer 502.

The second coil wiring layer 502 has a second contact portion R3 that is in contact with the first via wiring layer 601. In the present embodiment, the number of turns of the second coil wiring layer 502 is smaller than that in the case of the first embodiment. The first coil end portion E13 of the second coil wiring layer 502 does not overlap the first coil wiring layer 501 when viewed in the direction of the axis AX.

The first via wiring layer 601 has a first contact portion R1 that is in contact with the first coil wiring layer 501, a first non-contact portion R2 that is in no contact with the first coil wiring layer 501 and the second coil wiring layer 502, and a second contact portion R3 that is in contact with the second coil wiring layer 502. In the first via wiring layer 601, the direction from the first via end portion E21 to the second via end portion E23 is opposite to the direction from the first coil end portion E11 of the first coil wiring layer 501 to the second coil end portion of the first coil wiring layer 501.

As illustrated in FIG. 8, in the cross section taken along the center line in the extension direction of the first via wiring layer 601, the height of the first via wiring layer 601 at the first non-contact portion R2 is smaller than the height of the first coil wiring layer 501 and the first via wiring layer 601 at the first contact portion R1 or the height of the first via wiring layer 601 and the second coil wiring layer 502 at the second contact portion R3. Thus, in the first non-contact portion R2, the difference in coefficient of linear expansion between the first via wiring layer 601 and the first and third insulating layers 11a and 11c is reduced, and the thermal stress on the first via wiring layer 601 is reduced. Thus, the first via wiring layer 601 can reduce the occurrence of cracks.

Preferably, in a cross section taken along the center line in the extension direction of the first via wiring layer 601, the width of the first non-contact portion R2 is greater than the width of the first contact portion R1. At the first non-contact portion R2, the difference in coefficient of linear expansion between the first via wiring layer 601 and the first and third insulating layer 11a and 11c is reduced, and the thermal stress on the first via wiring layer 601 is further reduced. Thus, the first via wiring layer 601 can further reduce the occurrence of cracks.

The length of the first via wiring layer 601 may be the same as or smaller than the length in the first embodiment. The number of turns of the first coil wiring layer 501 may be the same as or greater than that in the first embodiment. The number of turns of the second coil wiring layer 502 may be the same as or greater than that in the first embodiment.

Instead of the above embodiments, the present disclosure may be changed in design within the scope not departing from the gist of the disclosure. For example, the features of the first and second embodiments may be combined in various manners. Instead, the coil wiring layers may be increased or decreased, or the via wiring layers may be increased or decreased. The top surface and the connection portion of the coil wiring layer may include a straight line portion or may have a curved shape.

The present disclosure includes the following aspects.

<1> An inductor component, comprising a body; a coil disposed in the body and helically wound about an axis; and a first outer electrode and a second outer electrode disposed at the body and electrically connected to the coil. The body has a first end surface and a second end surface opposite to each other, a first side surface and a second side surface opposite to each other, a bottom surface that connects the first end surface and the second end surface to each other and connects the first side surface and the second side surface to each other, and a top surface opposite to the bottom surface. The axis is parallel to the bottom surface and crosses the first side surface and the second side surface. The coil includes a first coil wiring layer and a second coil wiring layer laminated adjacent to each other in the axial direction, and a first via wiring layer that connects the first coil wiring layer and the second coil wiring layer to each other. The first coil wiring layer has a first coil end portion. The first via wiring layer has a first via end portion. Also, at least the first via end portion of the first via wiring layer is connected to a portion of the first coil wiring layer closer to the first coil end portion. In addition, when viewed in the axial direction, the first coil end portion of the first coil wiring layer is spaced apart from the first via end portion of the first via wiring layer without overlapping the first via end portion.

<2> The inductor component according to <1>, wherein the second coil wiring layer has a first coil end portion, the first via wiring layer has a second via end portion that is an end portion opposite to the first via end portion, and at least the second via end portion of the first via wiring layer is connected to a portion of the second coil wiring layer closer to the first coil end portion. Also, when viewed in the axial direction, the first coil end portion of the second coil wiring layer is spaced apart from the second via end portion of the first via wiring layer without overlapping the second via end portion.

<3> The inductor component according to <1> or <2>, wherein the first coil end portion of the first coil wiring layer has a first coil endmost portion located at an endmost portion in an extension direction of the first coil wiring layer, and the first via end portion of the first via wiring layer has a first via endmost portion located at an endmost portion in an extension direction of the first via wiring layer. Also, a distance between the first coil endmost portion of the first coil wiring layer and the first via endmost portion of the first via wiring layer is greater than or equal to 10 μm.

<4> An inductor component, comprising a body; a coil disposed in the body and helically wound about an axis; and a first outer electrode and a second outer electrode dispose d at the body and electrically connected to the coil. The body has a first end surface and a second end surface opposite to each other, a first side surface and a second side surface opposite to each other, a bottom surface that connects the first end surface and the second end surface to each other and connects the first side surface and the second side surface to each other, and a top surface opposite to the bottom surface. The axis is parallel to the bottom surface and crosses the first side surface and the second side surface. The coil includes a first coil wiring layer and a second coil wiring layer laminated adjacent to each other in the axial direction, and a first via wiring layer that connects the first coil wiring layer and the second coil wiring layer to each other. The first coil wiring layer has a first coil end portion, and the first coil end portion has a first coil endmost portion located at an endmost portion in an extension direction of the first coil wiring layer. The first via wiring layer has a first via end portion, and the first via end portion has a first via endmost portion located at an endmost portion in an extension direction of the first via wiring layer. Also, at least the first via end portion of the first via wiring layer is connected to a portion of the first coil wiring layer closer to the first coil end portion, and a distance between the first coil endmost portion of the first coil wiring layer and the first via endmost portion of the first via wiring layer is greater than or equal to 10 μm.

<5> The inductor component according to <3> or <4>, wherein a distance between the first coil endmost portion of the first coil wiring layer and the first via endmost portion of the first via wiring layer is greater than or equal to a width of the first coil wiring layer.

<6> The inductor component according to any one of <3> to <5>, wherein a distance between the first coil endmost portion of the first coil wiring layer and the first via endmost portion of the first via wiring layer is greater than or equal to a length of the first via wiring layer.

<7> The inductor component according to any one of <1> to <6>, wherein, when viewed in the axial direction, the first coil wiring layer and the second coil wiring layer at least partially overlap each other to have an overlapping portion, and an area of the first via wiring layer is smaller than or equal to 95% of an area of the overlapping portion.

<8> The inductor component according to any one of <1> to <7>, wherein, in a cross section taken along an extension direction of the first via wiring layer, a contact portion between the first via wiring layer and the first coil wiring layer is greater than a contact portion between the first via wiring layer and the second coil wiring layer.

<9> The inductor component according to any one of <1> to <8, wherein, when viewed in the axial direction, the first via wiring layer has a contact portion where the first via wiring layer is in contact with at least one of the first coil wiring layer and the second coil wiring layer, and a non-contact portion where the first via wiring layer is in no contact with the first coil wiring layer and the second coil wiring layer.

What is claimed is:

1. An inductor component, comprising:
a body having a first end surface and a second end surface opposite to each other, a first side surface and a second side surface opposite to each other, a bottom surface that connects the first end surface and the second end surface to each other and connects the first side surface and the second side surface to each other, and a top surface opposite to the bottom surface;
a coil in the body and helically wound about an axis that is parallel to the bottom surface and intersect the first side surface and the second side surface; and
a first outer electrode and a second outer electrode disposed at the body and electrically connected to the coil,
wherein
the coil includes a first coil wiring layer and a second coil wiring layer laminated adjacent to each other in an axial direction, and a first via wiring layer that connects the first coil wiring layer and the second coil wiring layer to each other,
the first coil wiring layer has a first coil end portion,
the first via wiring layer has a first via end portion,
at least the first via end portion of the first via wiring layer is connected to a portion of the first coil wiring layer closer to the first coil end portion of the first coil wiring layer, and
when viewed in the axial direction, the first coil end portion of the first coil wiring layer is spaced apart from the first via end portion of the first via wiring layer without overlapping the first via end portion.

2. The inductor component according to claim 1, wherein
the second coil wiring layer has a first coil end portion,
the first via wiring layer has a second via end portion that is opposite to the first via end portion,
at least the second via end portion of the first via wiring layer is connected to a portion of the second coil wiring layer closer to the first coil end portion of the second coil wiring layer, and
when viewed in the axial direction, the first coil end portion of the second coil wiring layer is spaced apart from the second via end portion of the first via wiring layer without overlapping the second via end portion.

3. The inductor component according to claim 1, wherein
the first coil end portion of the first coil wiring layer has a first coil endmost portion located at an endmost portion in an extension direction of the first coil wiring layer,
the first via end portion of the first via wiring layer has a first via endmost portion located at an endmost portion in an extension direction of the first via wiring layer, and
a distance between the first coil endmost portion of the first coil wiring layer and the first via endmost portion of the first via wiring layer is equal to or greater than 10 μm.

4. An inductor component, comprising:
a body having a first end surface and a second end surface opposite to each other, a first side surface and a second side surface opposite to each other, a bottom surface that connects the first end surface and the second end surface to each other and connects the first side surface and the second side surface to each other, and a top surface opposite to the bottom surface;
a coil in the body and helically wound about an axis that is parallel to the bottom surface and crosses the first side surface and the second side surface; and
a first outer electrode and a second outer electrode disposed at the body and electrically connected to the coil,
wherein
the coil includes a first coil wiring layer and a second coil wiring layer laminated adjacent to each other in an axial direction, and a first via wiring layer that connects the first coil wiring layer and the second coil wiring layer to each other,
the first coil wiring layer has a first coil end portion, and the first coil end portion has a first coil endmost portion located at an endmost portion in an extension direction of the first coil wiring layer,
the first via wiring layer has a first via end portion, and the first via end portion has a first via endmost portion located at an endmost portion in an extension direction of the first via wiring layer,
at least the first via end portion of the first via wiring layer is connected to a portion of the first coil wiring layer closer to the first coil end portion of the first coil wiring layer, and
a distance between the first coil endmost portion of the first coil wiring layer and the first via endmost portion of the first via wiring layer is equal to or greater than 10 μm.

5. The inductor component according to claim 3, wherein
a distance between the first coil endmost portion of the first coil wiring layer and the first via endmost portion of the first via wiring layer is equal to or greater than a width of the first coil wiring layer.

6. The inductor component according to claim 3, wherein
a distance between the first coil endmost portion of the first coil wiring layer and the first via endmost portion of the first via wiring layer is equal to or greater than a length of the first via wiring layer.

7. The inductor component according to claim 1, wherein
when viewed in the axial direction, the first coil wiring layer and the second coil wiring layer have an overlapping portion where the first coil wiring layer and the second coil wiring layer at least partially overlap to each other, and
an area of the first via wiring layer is equal to or smaller than 95% of an area of the overlapping portion.

8. The inductor component according to claim 1, wherein
in a cross section taken along an extension direction of the first via wiring layer, a contact portion between the first via wiring layer and the first coil wiring layer is larger than a contact portion between the first via wiring layer and the second coil wiring layer.

9. The inductor component according to claim 1, wherein
when viewed in the axial direction,
the first via wiring layer has a contact portion where the first via wiring layer is in contact with at least one of the first coil wiring layer and the second coil wiring layer, and
the first via wiring layer has a non-contact portion where the first via wiring layer is neither in contact with the first coil wiring layer nor in contact with the second coil wiring layer.

10. The inductor component according to claim 4, wherein
a distance between the first coil endmost portion of the first coil wiring layer and the first via endmost portion of the first via wiring layer is equal to or greater than a width of the first coil wiring layer.

11. The inductor component according to claim 4, wherein
a distance between the first coil endmost portion of the first coil wiring layer and the first via endmost portion of the first via wiring layer is equal to or greater than a length of the first via wiring layer.

12. The inductor component according to claim 2, wherein
when viewed in the axial direction, the first coil wiring layer and the second coil wiring layer have an overlapping portion where the first coil wiring layer and the second coil wiring layer at least partially overlap to each other, and
an area of the first via wiring layer is equal to or smaller than 95% of an area of the overlapping portion.

13. The inductor component according to claim 3, wherein
when viewed in the axial direction, the first coil wiring layer and the second coil wiring layer have an overlapping portion where the first coil wiring layer and the second coil wiring layer at least partially overlap to each other, and
an area of the first via wiring layer is equal to or smaller than 95% of an area of the overlapping portion.

14. The inductor component according to claim 4, wherein
when viewed in the axial direction, the first coil wiring layer and the second coil wiring layer have an overlapping portion where the first coil wiring layer and the second coil wiring layer at least partially overlap to each other, and
an area of the first via wiring layer is equal to or smaller than 95% of an area of the overlapping portion.

15. The inductor component according to claim 2, wherein
in a cross section taken along an extension direction of the first via wiring layer, a contact portion between the first via wiring layer and the first coil wiring layer is larger than a contact portion between the first via wiring layer and the second coil wiring layer.

16. The inductor component according to claim 3, wherein
in a cross section taken along an extension direction of the first via wiring layer, a contact portion between the first via wiring layer and the first coil wiring layer is larger than a contact portion between the first via wiring layer and the second coil wiring layer.

17. The inductor component according to claim 4, wherein
in a cross section taken along an extension direction of the first via wiring layer, a contact portion between the first via wiring layer and the first coil wiring layer is larger than a contact portion between the first via wiring layer and the second coil wiring layer.

18. The inductor component according to claim 2, wherein
when viewed in the axial direction,
the first via wiring layer has a contact portion where the first via wiring layer is in contact with at least one of the first coil wiring layer and the second coil wiring layer, and
the first via wiring layer has a non-contact portion where the first via wiring layer is neither in contact with the first coil wiring layer nor in contact with the second coil wiring layer.

19. The inductor component according to claim 3, wherein
when viewed in the axial direction,
the first via wiring layer has a contact portion where the first via wiring layer is in contact with at least one of the first coil wiring layer and the second coil wiring layer, and
the first via wiring layer has a non-contact portion where the first via wiring layer is neither in contact with the first coil wiring layer nor in contact with the second coil wiring layer.

20. The inductor component according to claim 4, wherein
when viewed in the axial direction,
the first via wiring layer has a contact portion where the first via wiring layer is in contact with at least one of the first coil wiring layer and the second coil wiring layer, and
the first via wiring layer has a non-contact portion where the first via wiring layer is neither in contact with the first coil wiring layer nor in contact with the second coil wiring layer.
